(19) United States
(12) Patent Application Publication
(10) Pub. No.: US 2015/0379859 A1
(43) Pub. Date: Dec. 31, 2015

(54) METHOD AND DEVICE FOR LOCATING AUTOMOTIVE KEY FOB, PORTABLE COMPUTING DEVICE, AND VEHICLE

(71) Applicant: DENSO International America, Inc., Southfield, MI (US)

(72) Inventor: Martin Nespolo, Rochester Hills, MI (US)

(21) Appl. No.: 14/319,028

(22) Filed: Jun. 30, 2014

(51) Int. Cl. G08B 21/24

(52) U.S. Cl. CPC G08B 21/24

(57) ABSTRACT

A method for locating a desired device by a position detection module residing on a portable computing device. The method includes: receiving, by the position detection module, a communication signal over a communication link from the a desired device; correlating, by the position detection module, a position of the desired device with respect to the portable computing device, wherein the correlating is based in part of a characteristic of the communication signal; and outputting, by the position detection module, a signal detection alert, wherein the signal detection alert indicates a location from which the communication signal originated. The desired device may be a vehicle or a vehicular key fob.

### FIELD

The present disclosure relates to locating an automotive key fob a portable computing device, and/or a vehicle. More particularly, the present disclosure relates to locating a desired device, such as the automotive key fob, the portable computing device or the vehicle, by analyzing a signal received from the desired device.

### BACKGROUND

This section provides background information related to the present disclosure which is not necessarily prior art.

Many vehicle owners have experienced the frantic search resulting from a misplaced vehicle key fob. While various devices may be available to detect the position of a misplaced key fob, such devices may rely on separate communication links and may require the user to utilize a separate dedicated device.

It is generally known that a user may gain access of the vehicle without the key fob by way of a portable computing device, such as a smartphone. More particularly, the vehicle, the key fob, and the portable device wirelessly communicate with one another via a communication link. Once within communication range, the key fob and/or the portable computing device can be utilized to perform various operations of the vehicle, such as remote start, passive entry, passive start, and/or locking/unlocking doors. While the key fob and the portable computing device may be out of communication range with the vehicle, the key fob and the portable computing device may continue to communicate with one another via the established wireless communication link.

### SUMMARY

This section provides a general summary of the disclosure, and is not a comprehensive disclosure of its full scope or all of its features.

The present disclosure provides for a method for locating a desired device by a position detection module. The position detection module may reside on a portable computing device, such as a smartphone. The method includes receiving a communication signal over a communication link from the desired device. The method further includes correlating a position of the desired device with respect to the portable computing device. Specifically, using known signal localization techniques, the correlation can be based in part of a characteristic of the communication signal. Based on the correlation, the method further includes outputting a signal detection alert, which generally indicates a location from which the communication signal originated. The desired device may be a key fob and/or a vehicle, which may transmit a signal to the portable computing device.

In another aspect of the present disclosure, a key fob may include a position detection module. The position detection module locates a desired device based on a signal received from the desired device. The position detection module analyzes a characteristic of the signal received from the desired device and correlates a position of the desired device based on the characteristic analyzed. The desired device may include a portable computing device and/or a vehicle.

In another aspect of the present disclosure a vehicle may include a position detection module. The position detection module locates a desired device based on a signal received from the desired device. The position detection module analyzes a characteristic of the signal received from the desired device and correlates a position of the desired device based on the characteristic analyzed. The desired device may include a portable computing device and/or a key fob.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates communication between a vehicle, a portable computing device, and a key fob via a wireless communication link;

FIG. 2 is an example block diagram of the key fob;

FIG. 3 is an example block diagram of the portable computing device having a position detection module;

FIG. 4 is an example block diagram of the position detection module;

FIG. 5 illustrates a gauge of the portable computing device;

FIG. 6 is a flowchart of an example method for initiating a locator function performed by the position detection module;

FIG. 7 is a flowchart of an example method for locating a desired device;

FIG. 8. is an example block diagram of the key fob having a portable detection module; and

FIG. 9 is an example block diagram of the vehicle having a portable detection module.

Corresponding reference numerals indicate corresponding parts throughout the several views of the drawings.

### DETAILED DESCRIPTION

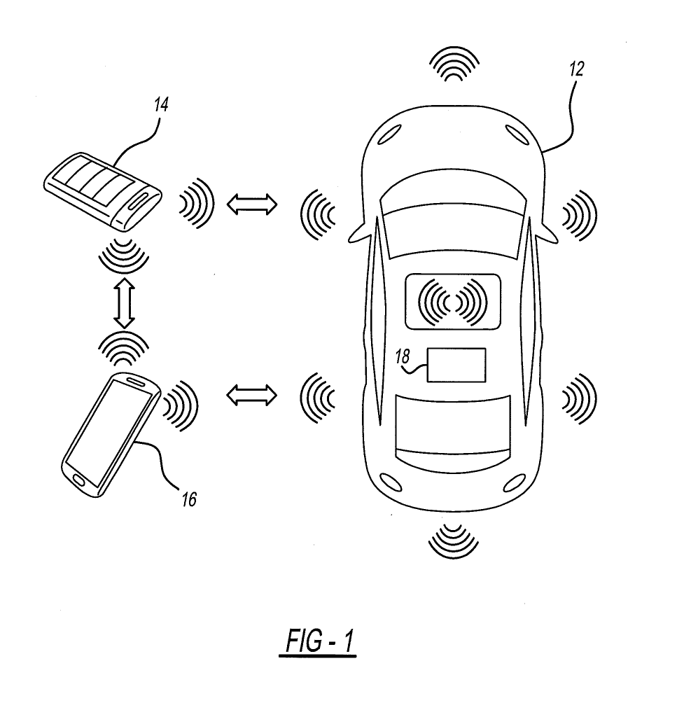

The present disclosure will now be described more fully with reference to the accompanying drawings. With reference to FIG. 1, a vehicle 12, a key fob 14, and a portable computing device 16 (“portable device” hereinafter) may transmit and/or receive data signals with one another via a wireless communication link. For example, the wireless communication link may include the Bluetooth wireless technology standard (e.g., low energy feature of Bluetooth 4.0), a WiFi network connection, or other suitable wireless connections.

The vehicle 12 may include a communication module 18 which transmits and receives information from devices external of the vehicle 12, such as the key fob 14 and the portable device 16. The communication module 18 may include a wireless transceiver, one or more antennas disposed along the vehicle 12, and a microcontroller. The communication module 18 may transmit and receive data from other modules within the vehicle by way of a vehicle communication network. The vehicle communication network may include CAN, LIN, or other suitable vehicle networks.

As used herein, the term module may refer to, be part of, or include an application Specific Integrated Circuit (ASIC); an electronic circuit; a combinational logic circuit; a field programmable gate array (FPGA); a processor (shared, dedicated, or group) that executes code; other suitable components that provide the described functionality; or a combination of some or all of the above. The term module may further include memory that stores code executed by the processor, where code, as used above, may include software, firmware, and/or microcode, and may refer to programs, routines, functions, classes, and/or objects.

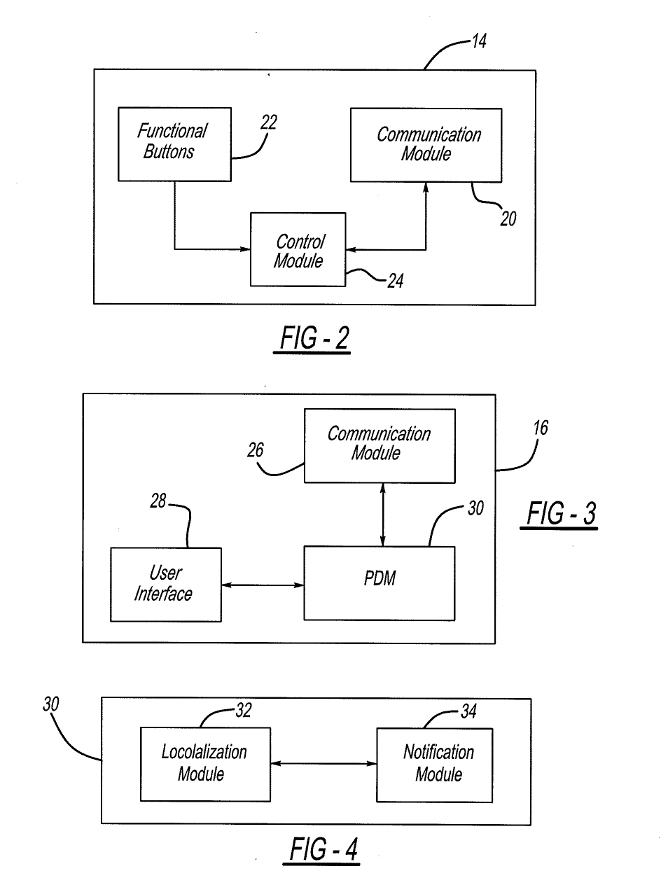

With reference to FIG. 2, an example of the key fob 14 is presented. The key fob 14 may include a communication module 20, one or more functional buttons 22, and a control module 24. The communication module 20 may include a transceiver, such as a Bluetooth transceiver or a radio frequency transceiver. The communication module 20 transmits and receives signals from external devices such as the vehicle 12 and the portable device 16.

The functional buttons 22 cause the key fob 14 to transmit a signal to carry out a particular function designated by the button when the functional button is operated by a user. For example, when an unlock button is operated, the key fob 14 transmits a signal via the communication module 20 to the vehicle 12 to unlock the doors of the vehicle 12. The key fob 14 may include functional buttons associated with doors lock/unlock, remote start, alarm, trunk open/close, lift gate open/close, windows open/close.

The control module 24 communicates with the functional buttons 22 and the communication module 20. For example, when a given functional button 22 is operated, the control module 24 may receive an input from the given functional button 22 and instruct the communication module 20 to transmit a signal to the vehicle 12 in order to carry out the particular function. When the communication module 20 receives a signal from an external device, the control module 24 may analyze the signal to identify the external device and determine whether a response is needed. For example, if the communication module 20 receives a communication request from the portable device 16, the control module 24 may have the communication module 20 transmit a signal to the portable device 16.

With reference to FIG. 3, an example of the portable device 16 is now described. The portable device 16 may be a smartphone, a tablet computer, a laptop, or other suitable computing devices which can be carried by a user. The portable device 16 may include a communication module 26 and a user interface 28. The communication module 26 may include a wireless transceiver, such as a Bluetooth transceiver and/or a radio frequency transceiver. The communication module 26 transmits and receives signals from external devices such as the vehicle 12 and the key fob 14. The user interface 28 may include a touch screen, buttons, a speaker, and/or a microphone. While the present disclosure discusses primary components of the portable device 16 and the key fob 14, it is understood that other components may be needed for the overall operation of the portable device 16 and/or the key fob 14 such as a power supply.

The portable device 16 may include a position detection module (“PDM” in drawings) 30 for locating a desired device, such as the key fob 14. More particularly, the position detection module 30, which may be an application stored on the portable device 16, performs as a locator for detecting the position of a desired device. For example, the user of a vehicle 12, such as the owner, may misplace the key fob 14. The position detection module 30 aids the user in locating the misplaced key fob 14 via signals received from the key fob 14.

With reference to FIG. 4, a functional block diagram of the position detection module 30 is presented. The position detection module 30 includes a localization module 32 and a notification module 34. The localization module 32 analyzes selected signals received by the communication module 26 of the portable device 16 to generally locate the origin of the signal. More particularly, the localization module 32 analyzes signals from the desired device to determine the positional relationship of the desired device with respect to the position detection module 30, or, in other words, the portable device 16.

The localization module 32 may filter the signals from the desired device from other signals received by the communication module 26. The localization module 32 may initiate communication with the desired device by having the communication module 26 transmit a signal to the desired device. Once a signal from the desired device is received, the localization module 32 may analyze the signal to localize the position of the desired device. Specifically, using known signal localization techniques, the localization module 32 analyzes one or more characteristics of the signal. For example, the localization module 32 may employ received signal strength indicator (RSSI), time of arrival (TOA), and/or angle of arrival (AOA) for analyzing the signal from the desired device.

Under RSSI, the position detection module 30 determines the strength of a signal that is received by the communication module 26 from a transmitting device, such as the desired device. The strength of the signal increases as the distance between the position detection module 30 and the transmitting device decreases. Conversely, the strength of the signal decreases as the distance between the position detection module 30 and the transmitting device decreases.

Under TOA, the time at which the signal is received can be used to determine the general location of the transmitting device. For example, the time at which a signal is transmitted from the transmitting device and then received by the position detection module 30 decreases as the distance between the position detection module 30 and the transmitting device decreases. On the other hand, the time increases as the distance between the position detection module 30 and the transmitting device increases.

Under AOA, the position detection module 30 analyzes the signal to determine the angle at which the signal is received. Based on the angle, the direction from which the signal originated from can be determined. In other words, the location of the transmitting device is determined relative to the position detection module 30. While the example embodiment discloses using RSSI, TOA, and/or AOA for locating the origin of the signal, it is understood that other localization algorithms may be used, such as time delay of arrival (TDOA), time of flight (TOF), etc.

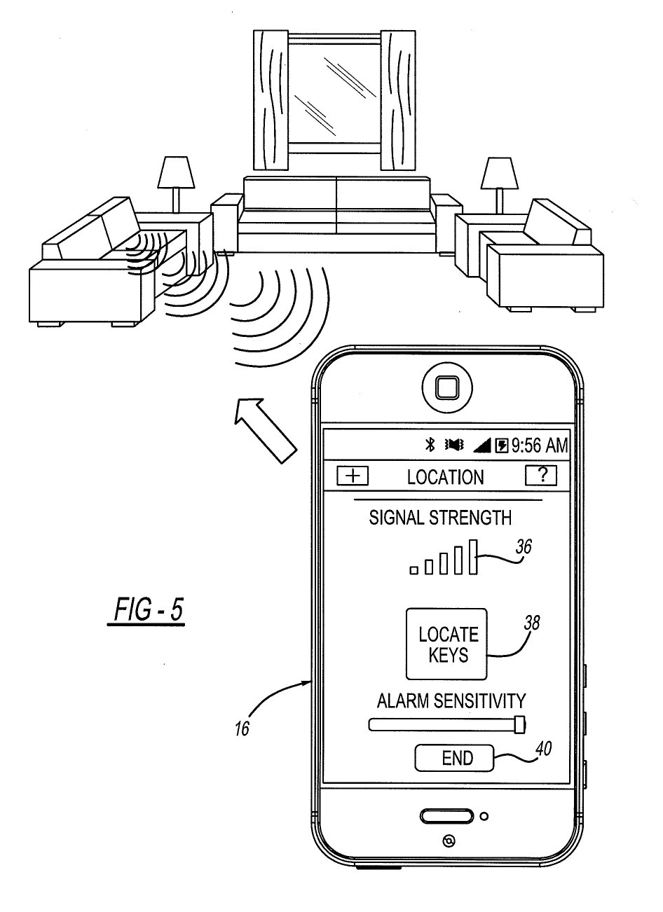

As the localization module 32 analyzes the signals, the notification module 34 provides an alert to the user to guide the user toward the desired device. For example, with reference to FIG. 5, the notification module 34 may display a gauge 36 that generally reflects the position of the desired device relative to the portable device 16 based on the analysis performed by the localization module 32. For example, the gauge 36 may depict the strength of the signals being received from the desired device. As the portable device 16 moves toward the desired device, the gauge 36 would indicate an increase in signal strength, and as the portable device 16 moves away from the desired device, the gauge 36 would indicate a decrease in signal strength. Accordingly, the user is directed toward the desired device, such as the key fob 14, via the position detection module 30 by the change in signal strength.

While the gauge 36 is provided as displaying the change in signal strength, it is readily understood that the gauge 36 can display other characteristics of the signals. For example, using TOA or AOA, the gauge 36 may be a compass or arrows that direct the user toward the desired device. The gauge 36 may also be a thermal map which highlights the position of the desired device.

In addition to or in lieu of the gauge 36, the notification module 34 may emit a sound, provide a haptic feedback, or provide other suitable notifications based on the analysis performed by the localization module 32. For example, the notification module 34 may increase the tempo of a sound, which can be emitted by an audio system of the portable device 16, as the position detection module 30 moves closer to the desired device and decrease the tempo of the sound as the position detection module 30 moves away from the desired device. Furthermore, if the portable device 16 has a haptic feedback system, the notification module 34 may provide, for example, a vibration pulse which varies based on the position of the desired device relative to the position detection module 30.

The notification module 34 may also display a button for activating and deactivating the locator. For example, the notification module 34 may display a start button 38 (“Locate Keys” in FIG. 5) and an end button 40. In the example embodiment, when the start button 38 is operated, the localization module 32 begins to analyze the signals received from the key fob 14, and the notification module 34 begins to display the gauge 36 and/or emit a sound which reflects a general location or direction of the key fob 14. When operated by the user, the end button 40 deactivates the locator, such that localization module 32 stops analyzing the signals being received and the notification module 34 turns off the gauge 36. While the example embodiment depicts buttons 38, 40 for activating or deactivating the locator, other suitable methods may be used to activate and deactivate the locator. For example, the locator may be activated and deactivated by a voice command, a predefined movement of the portable device, etc.

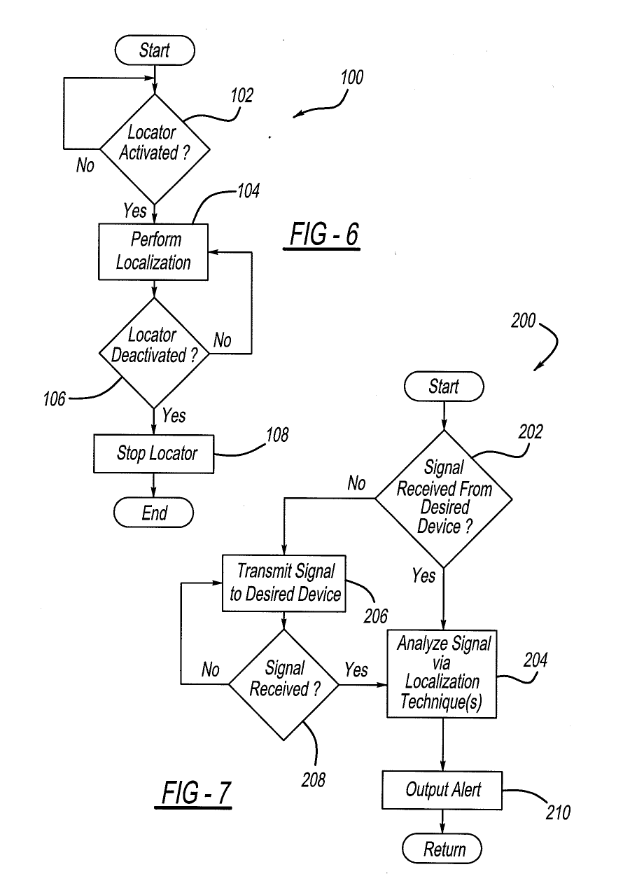

With reference to FIG. 6, a flowchart of an example method 100 for initiating the locator to find the desired device is now described. The position detection module 30 may perform the method 100. At 102, the position detection module 30 determines whether the locator has been activated. For example, the position detection module 30 may detect that the start button 38 displayed on the portable device 16 has been operated by the user. If the locator has been activated, the position detection module 30 performs a localization process at 104. If the locator has not been activated, the position detection module 30 remains at 102.

At 104 the position detection module 30 performs the localization process which is described in detail below. At 106 the position detection module 30 determines whether the locator should be deactivated. For example, when the user operates the end button 40, the position detection module 30 determines that the locator should be deactivated or turned off. Accordingly, if the position detection module 30 determines that the locator should be deactivated, the position detection module 30 stops the locator at 108. Specifically, the position detection module 30 stops performing the localization process.

With reference to FIG. 7, a flowchart of an example method 200 of the localization process performed at 104 of method 100 is presented. The position detection module 30 performs method 200 until the locator is stopped as determined in method 100. At 202, the position detection module 30 determines whether a signal is received from the desired device, such as the key fob 14. For example, the position detection module 30 may receive various signals via the communication module 26. The position detection module 30 may identify the device that transmitted the signal by way of, for example, a key code or encryption. If a signal has been received from the desired device, the position detection module 30 continues to 204. If a signal has not been received from the desired device, the position detection module 30 continues to 206.

At 206, the position detection module 30 transmits a signal to the desired device via the communication module 26. Specifically, the position detection module 30 initiates communication with the desired device which may be waiting for a communication request. At 208, the position detection module 30 determines whether a signal has been received from the desired device. More particularly, after sending the communication request, the position detection module 30 waits for a reply from the desired device. If a signal has been received, the position detection module continues to 204. If a signal has not been received, the position detection module 30 retransmits a signal to the desired device at 206. The position detection module 30 may also notify the user via the user interface 28 that the desired device has not been detected in the area. In other words, it is possible that the desired device may be far from the portable device 16, such that the portable device 16 and the desired device are not in communication via the wireless communication link. Accordingly, the user may be advised to move to a different location.

At 204, the position detection module 30 analyzes the signal received via a localization technique to determine a positional relationship of the position detection module 30 and the desired device. For example, the position detection module 30 may analyze the signal using RSSI, TOA, and/or AOA, to determine the origin of the signal. After analyzing the signal, the position detection module 30 outputs an alert based on the signal analysis at 210. For example, the position detection module 30 may display the gauge 36, emit a sound, and/or provide other suitable alerts/notification. The position detection module 30 returns to 202 to continue analyzing the signals received from the desired device until the locator is deactivated, as determined at 106 by the method 100.

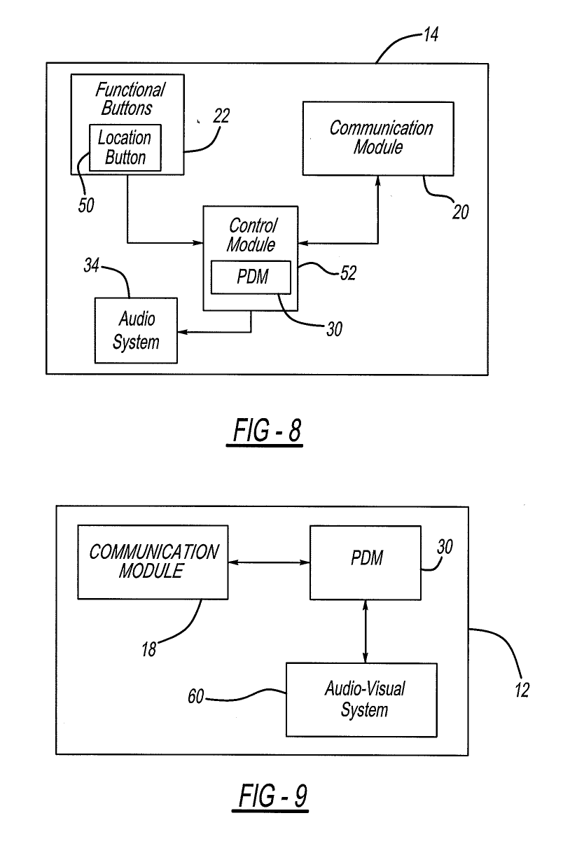

In the example embodiment, the position detection module 30 is disposed on the portable device 16 to locate the desired device, such as the key fob 14 and/or vehicle. The position detection module 30 may also be integrated with the key fob 14 and/or the vehicle 12. For example, with reference to FIG. 8, the key fob 14 may include a locator button 50 as part of the one or more functional buttons 22. The key fob 14 further includes a control module 52 which includes the position detection module 30. When the locator button 50 is operated, the control module 52 has the position detection module 30 locate the desired device. The key fob 14 may include an audio system 54 which emits a sound. Accordingly, the notification module 34 of the position detection module 30 may output the alert in the form of a sound via the audio system 54 as the localization module 32 performs the signal analysis.

With the position detection module 30 disposed with the key fob 14, the position detection module 30 performs the methods 100 and 200 for locating the desired device. For example, at 102 of method 100, the position detection module 30 may determine that the locator has been activated when the locator button 50 is operated, and, at 106, may determine that the locator is deactivated when the locator button 50 is operated again.

While the example embodiment discloses locating the key fob 14 or the portable device 16, the position detection module 30 may also locate the position of the vehicle 12. Specifically, if the portable device 16 is in close proximity to the vehicle 12, the portable device 16 can locate the vehicle 12 by analyzing the signals received from the vehicle 12. For example, it is common for users to forget the exact location of his/her vehicle in a parking lot or parking structure. The position detection module 30 may assist the user in locating the vehicle 12 by analyzing signals received from the vehicle 12 in a similar manner as described above with regard to the key fob 14.

The position detection module 30 of the portable device 16 may distinguish between locating the key fob 14 and locating the vehicle 12 using various suitable methods. For example, the notification module 34 may display one start button for locating the key fob 14 and one start button for locating the vehicle 12. Alternatively, when the start button is operated, the user may be asked to select the desired device as either the key fob 14 or the vehicle 12. Similarly, the position detection module 30 provided on the key fob 14 may also be configured to locate the vehicle 12.

With reference to FIG. 9, the vehicle 12 may also include the position detection module 30 which may receive signals from the key fob 14 and/or the portable device 16. The position detection module 30 disposed in the vehicle 12 may be used to locate the key fob 14 and/or portable device 16. For example, the position detection module 30 may be communicably coupled to an audio-visual system 60 and the communication module 18 of the vehicle 12. The user may be able to request the position detection module 30 to locate the key fob 14 and/or the portable device 16 via a menu being displayed on a display (e.g., liquid crystal display) of the audio-visual system 60 or a voice command received via of the audio-visual system 60. The notification module 34 of the position detection module 30 may output the alert in the form of a sound and/or graphical representation via the of the audio-visual system 60 as the localization module 32 performs the signal analysis.

With the position detection module 30 disposed in the vehicle 12, the position detection module 30 performs the methods 100 and 200 for locating the desired device. For example, at 102 of method 100, the position detection module 30 may determine that the locator has been activated or deactivated when a button displayed by the audio-visual system 60 is operated or when a voice command is received via the audio-visual system 60.

By utilizing the data signals being transmitted and/or received between the key fob 14, the portable device 16, and the vehicle 12, the position detection module 30 is able to determine the position of one device relative to the other device by analyzing the signals being received. Since the portable device 16 and the key fob 14 are typically located in close proximity of one another, the portable device 16 is able to receive and analyze the signals from the key fob 14 to determine the location of the key fob 14 relative to the portable device 16. Similarly, the key fob 14 and the vehicle 12 may also locate each other and/or the portable device 16.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. As used herein, the term “and/or” includes any and all combinations of one or more of the associated listed items.

What is claimed is:

1. A method for locating a desired device by a position detection module residing on a portable computing device, the position detection module is implemented as computer executable instructions executed by a computer processor of the portable computing device, the method comprising:
receiving, by the position detection module, a communication signal over a communication link from the desired device;
correlating, by the position detection module, a position of the desired device with respect to the portable computing device, wherein the correlating is based in part of a characteristic of the communication signal; and
outputting, by the position detection module, a signal detection alert, wherein the signal detection alert indicates a location from which the communication signal originated.

2. The method of claim 1 wherein the characteristic of the communication signal is a strength of the signal.

3. The method of claim 1 wherein the correlating the position of the desired device with respect to the portable computing device further comprising:
performing, by the position detection module, a time of arrival analysis of the communication signal received to locate the desired device with respect to the portable computing device, wherein the characteristic of the communication signal at least includes a time at which the communication signal was received.

4. The method of claim 1 wherein the correlating the position of the desired device with respect to the portable computing device further comprising:
performing, by the position detection module, an angle of arrival analysis of the communication signal received to locate the desired device with respect to the portable computing device, wherein the characteristic of the communication signal at least includes an angle at which the communication signal was received.

5. The method of claim 1 wherein the outputting the signal detection alert further comprises:
displaying, by the position detection module, a visual representation of the location of the desired device with respect to the portable computing device.

6. The method of claim 1 wherein the outputting the signal detection alert further comprises:
outputting, by the position detection module, a sound that varies based on the location of the desired device with respect to the portable computing device.

7. The method of claim 1 wherein the desired device is at least one of a vehicle or a vehicular key fob.

8. A portable computing device communicating with a vehicular key fob and a vehicle by way of a wireless communication link, the portable computing device comprising:
a communication module receiving signals from the vehicular key fob or the vehicle or both when within communication range;
a position detection module locating a desired device based on a signal received from the desired device via the communication module, wherein the position detection module analyzes a characteristic of the signal received from the desired device and correlates a position of the desired device based on the characteristic analyzed; and
a user interface displaying a signal detection alert, wherein the signal detection alert indicates a location from which the signal originated based on an analysis of the signal by the position detection module.

9. The portable computing device of claim 8 wherein the user interface includes an audio system and the user interface outputs a sound that varies based on the location of the desired device.

10. The portable computing device of claim 8 wherein the desired device is at least one of the vehicle or the vehicular key fob.

11. The portable computing device of claim 8 wherein the position detection module locates the desired device based on a time of arrival analysis of the signal received from the desired device wherein the characteristic of the signal at least includes a time at which the signal was received.

12. The portable computing device of claim 8 wherein the position detection module locates the desired device based on an angle of arrival analysis of the signal received from the desired device wherein the characteristic of the signal at least includes an angle at which the signal was received.

13. The portable computing device of claim 8 wherein the position detection module locates the desired device based on a strength of the signal received from the desired device.

14. A vehicular key fob communicating with a portable computing device and a vehicle by way of a wireless communication link, the vehicular key fob comprising:
a communication module receiving signals from the portable computing device or the vehicle or both when within communication range;
one or more functional buttons performing a designated function when operated, wherein the one or more function buttons includes a locator button;
a position detection module locating a desired device based on a signal received from the desired device via the communication module when the locator button is operated, wherein the position detection module analyzes a characteristic of the signal received from the desired device and correlates a position of the desired device based on the characteristic analyzed; and
an audio system outputting a sound, wherein the audio system varies the sound based on the location of the desired device.

15. The vehicular key fob of claim 14 wherein the desired device is at least one of the portable computing device or the vehicle.

16. The vehicular key fob of claim 14 wherein the position detection module locates the desired device based on a time of arrival analysis of the signal received from the desired device wherein the characteristic of the signal at least includes a time at which the signal was received.

17. The vehicular key fob of claim 14 wherein the position detection module locates the desired device based on an angle of arrival analysis of the signal received from the desired device wherein the characteristic of the signal at least includes an angle at which the signal was received.

18. The vehicular key fob of claim 14 wherein the position detection module locates the desired device based on a strength of the signal received from the desired device.

19. A vehicle communicating with a portable computing device and a vehicular key fob by way of a wireless communication link, the vehicle comprising:
a communication module receiving signals from the portable computing device or the vehicular key fob or both when within communication range;
a position detection module locating a desired device based on a signal received from the desired device via the communication module, wherein the position detection module analyzes a characteristic of the signal received from the desired device and correlates a position of the desired device based on the characteristic analyzed; and
an audio-visual system outputting an alert, wherein the alert indicates a location from which the signal originated based on an analysis of the signal by the position detection module.

20. The vehicle of claim 19 wherein the desired device is at least one of the portable computing device or the vehicular key fob.
